(19) United States
(12) Patent Application Publication
(10) Pub. No.: US 2007/0141410 A1
(43) Pub. Date: Jun. 21, 2007

(54) Direct oxidation fuel cell system

(75) Inventor: Takashi Akiyama, Suita-shi (JP)

Correspondence Address: MCDERMOTT WILL & EMERY LLP, 600 13TH STREET, NW, WASHINGTON, DC, 20005-3096, US

(73) Assignee: MATSUSHITA ELECTRIC INDUSTRIAL CO., LTD.

(21) Appl. No.: 11/300,502

(22) Filed: Dec. 15, 2005

(51) Int. Cl. H01M 8/04; H01M 8/10; H01M 8/20

(52) U.S. Cl. 429/22; 429/30; 429/34

(57) ABSTRACT

This invention relates to a direct oxidation fuel cell system in which a liquid organic fuel or an aqueous solution thereof is supplied from a fuel tank to the anode of a fuel cell. This fuel cell system includes a discharge path for discharging a fluid that comprises gas and liquid from the anode of the fuel cell. The discharge path is equipped with a gas-liquid detector that comprises a tubular part for distinguishing whether the fluid passing through the tubular part is in gaseous form or liquid form, and a switching valve disposed downstream of the gas-liquid detector. This system further includes an anode-side recovery path that branches off from the switching valve and leads to the fuel tank, and a controller for switching the switching valve based on an output signal from the gas-liquid detector to recover the liquid in the discharge path.

### FIELD OF THE INVENTION

The present invention relates to a direct oxidation fuel cell system in which a liquid fuel is directly supplied to the anode and oxidized.

### BACKGROUND OF THE INVENTION

Fuel cells are roughly classified into phosphoric acid type, alkaline type, molten carbonate type, solid oxide type, and solid polymer type, according to the kind of the electrolyte they employ. Among them, solid polymer fuel cells, which are capable of operating at low temperatures and have high output densities, are becoming commercially practical in such applications as automobile power sources and domestic cogeneration systems.

Meanwhile, portable appliances, such as notebook personal computers, cellular phones and PDAs, have recently been becoming more and more sophisticated, and the electric power consumed thereby tends to increase commensurately. Such portable appliances are currently powered by lithium ion secondary batteries and nickel-metal hydride secondary batteries, but manufacturers of these batteries have failed to improve energy density so as to keep up with the recent increase in power consumption. Under such circumstances, a problem of capacity shortage of power sources is a matter of concern.

As a new power source that can solve this problem, solid polymer fuel cells (hereinafter referred to as PEFCs) have been receiving attention. Among them, direct oxidation fuel cells can generate electric energy by directly oxidizing fuel at the electrode, without the need to reform fuel that is liquid at ordinary temperature into hydrogen. Direct oxidation fuel cells are most promising in that they need no reformer and permit an easy reduction in the size of power sources.

With respect to the fuel to be fed to direct oxidation fuel cells, low-molecular-weight alcohols and ethers have been examined. Among them, methanol offers a high energy efficiency and a high output. Thus, direct methanol fuel cells (hereinafter referred to as DMFCs), which use methanol as the fuel, are most promising.

The anodic and cathodic reactions of a DMFC are represented by the following formulae (1) and (2), respectively. Oxygen serving as the oxidant on the cathode is typically taken in from air.
CH₃OH+H₂O→CO₂+6H⁺+6e⁻ (1)
3/2O₂+6H⁺+6e⁻→3H₂O (2)

Methods for supplying fuel are roughly classified into two types. In one type, a fuel tank for storing fuel is connected to the anode side of a fuel cell through a liquid communication path such that the fuel reaches the anode by concentration diffusion or convection of liquid. Alternatively, a hydrophilic material such as hydrophilic non-woven fabric is provided between the fuel tank and the anode side such that the fuel is supplied to the anode by capillary osmosis. Fuel cells of this type are generally referred to as passive-type fuel cells.

In the other type, a pump for supplying fuel is provided between a fuel tank and a fuel cell such that the fuel is supplied to the fuel cell by the driving power of the pump. Fuel cells of this type commonly use the so-called carbon separator plate composed of a carbon plate that has a channel in one face thereof so as to cover the electrode-facing area thereof, in order to improve the evenness of the fuel supply in the direction of electrode surface. In employing this type of fuel supply method, it is common to supply fuel in excess of the amount of fuel that is stoichiometrically equal to the amount of fuel consumed by power generation and to recover surplus fuel, such that the voltage generated by the cell will not be lowered by concentration polarization at the anode. Fuel cells of this type are generally referred to as active-type fuel cells.

Similarly, supply methods of air containing oxygen as the oxidant are also classified into an active-type, in which air is forcedly supplied to the cathode by means of an auxiliary device such as a pump, and a breathing type, in which air is supplied only by circulation of air due to convection of gas without using any auxiliary device.

In either type, a mechanism is necessary for discharging carbon dioxide generated in the anode, as shown by formula (1), from the fuel cell system while not discharging fuel from the fuel cell system. Thus, for example, Japanese Laid-Open Patent Publication No. Sho 58-35875 proposes using a gas-liquid separating film to keep liquid in a fuel cell and discharge gaseous carbon dioxide.

The gas-liquid separating film utilizes the fact that liquid moves in a particular direction because of gravity and difference in specific gravity. Thus, if the fuel cell is turned upside down, the gas-liquid separating film is covered by liquid, so that gas permeability is destroyed and the discharge of carbon dioxide is impeded. In order for a fuel cell system to function as the power source of a portable electronic appliance, the gas-liquid separation needs to function properly even if the orientation of the fuel cell is changed.

Such an improvement is proposed in Japanese Laid-Open Patent Publication No. Sho 60-62064, in which a plurality of gas discharge apertures are formed at different positions of a gas-liquid separating tank such that even if the tank is inclined, carbon dioxide can be discharged from any one of the gas discharge apertures.

With regard to the electrolyte membrane of DMFCs, a perfluorosulfonic acid film, such as Nafion (Nafion is a registered trademark of E.I. Du Pont de Nemours & Company), is typically used in the same manner as in PEFCs that use hydrogen as the fuel. However, the use of such an electrolyte membrane has a problem in that power generation performance is degraded by the crossover phenomenon, i.e., permeation of fuel through the electrolyte membrane into the cathode. For example, when the fuel is methanol, methanol is oxidized at the cathode, as shown by formula (3). In this case, since the potential of the cathode is the sum of the potential as shown by formula (2) and the potential as shown by formula (3), the potential of the cathode lowers, thereby resulting in a decrease in the voltage generated by the fuel cell.
CH₃OH+ 3/2O₂→CO₂+2H₂O (3)

The driving force of such crossover phenomenon is mainly derived from molecular diffusion due to concentration gradient and electro-osmotic drag by protons. Thus, the amount of crossover fuel is largely dependent on fuel concentration and temperature inside the anode. Therefore, in order to reduce performance degradation caused by crossover fuel, the concentration of fuel reaching the electrode must be lowered. For example, the above-mentioned fuel cell of the active type commonly uses a diluted aqueous solution with a fuel concentration of approximately 1 to 2 mol/l.

However, storing a low-concentration fuel in the fuel tank lowers the energy density of the fuel cell system, increases the frequency of fuel resupply, and lowers user convenience.

In order to solve such problems, it is conventional to employ a system configuration in which the water discharged from the cathode is actively recovered, the recovered water is mixed with a relatively high concentration fuel stored in the fuel tank, and the resultant mixture is supplied to the anode.

Regarding such a fuel cell system, a method for recovering only a necessary amount of water from the fluid discharged from the cathode is described in Japanese Laid-Open Patent Publication No. 2004-152561. This method proposes providing an air supply pump between the discharge outlet of the cathode and the cold trap, recovering one third of the water produced at the cathode, and evaporating the remaining water into ambient air.

As described above, in direct oxidation fuel cells of the active type, the fluid discharged from the anode or the cathode is a gas-liquid two-phase fluid, i.e., a fluid comprising gas and liquid. This fluid contains large amounts of reusable fuel or water. Hence, in order to improve the energy efficiency of a fuel cell system and improve the convenience of the fuel cell used as a power source, it is important to effectively recover liquid components and supply them to the electrode.

However, the disclosure of Japanese Laid-Open Patent Publication No. Sho 58-35875 suffers from the problem of the gas-liquid separating film being clogged when the fuel cell system is turned upside down. With respect to the disclosure of Japanese Laid-Open Patent Publication No. Sho 60-62064, the amount of liquid contained in the gas-liquid separating tank is limited, and the large loss in space becomes an obstacle in reducing the size of the fuel cell system. Specifically, the size of the gas-liquid separating tank must be larger than the volume of liquid contained therein such that even if the tank is inclined, at least one of the gas discharge apertures will not be closed with the liquid.

As for the recovery of water discharged from the cathode, there is a problem as described in Japanese Laid-Open Patent Publication No. 2004-152561. That is, since the amount of water evaporation is largely dependent on temperature and air flow rate, precisely recovering only a necessary amount of water requires precise temperature control and air flow rate control.

If only the water produced by power generation is taken into consideration, the amount of water as described in Japanese Laid-Open Patent Publication No. 2004-152561 is discharged from the cathode. However, in reality, due to the above-mentioned fuel crossover phenomenon, water is also produced in the combustion reaction of fuel that has reached the cathode, as shown by formula (3).

Further, in using an electrolyte membrane that conducts protons upon hydration of the electrolyte membrane itself, such as those currently used, it is known that water molecules themselves migrate from the anode to the cathode due to molecular diffusion and electro-osmotic drag of protons. The amount of water migration is often several times as much as the amount of water produced by formula (2), although it varies with electrode design.

Therefore, the amount of water to be evaporated into air in the evaporation part as described in Japanese Laid-Open Patent Publication No. 2004-152561 is estimated to be considerably large. This involves thermal energy loss due to temperature control and energy loss due to pumping for supplying sufficient air, and it is thus difficult to obtain a system with a high energy efficiency.

Accordingly, there is a demand for fuel cell systems that are small and provide high energy densities and high user conveniences.

### BRIEF SUMMARY OF THE INVENTION

The present invention provides a direct oxidation fuel cell system including: a direct oxidation fuel cell comprising at least one cell that comprises an anode, a cathode and a polymer electrolyte membrane inserted between the anode and the cathode; a fuel tank for storing a liquid organic fuel or an aqueous solution thereof; a fuel supply path for supplying the liquid organic fuel or the aqueous solution thereof from the fuel tank to the anode of the fuel cell; an anode-side discharge path for discharging a fluid from the anode of the fuel cell, the fluid comprising gas and liquid that comprise a by-product and a residue of the liquid organic fuel or the aqueous solution thereof; an anode-side gas-liquid detector comprising a tubular part that is provided in the anode-side discharge path for distinguishing whether the fluid passing through the tubular part is in gaseous form or liquid form; an anode-side switching valve disposed downstream of the anode-side gas-liquid detector of the anode-side discharge path; an anode-side recovery path for recovering the liquid contained in the fluid discharged from the anode, the recovery path branching off from the anode-side switching valve and leading to the fuel tank; an oxidant supply path for supplying an oxidant to the cathode of the fuel cell; a cathode-side discharge path for discharging a fluid from the cathode of the fuel cell, the fluid comprising gas and liquid that comprise a by-product and a residue of the oxidant; and a controller for switching the anode-side switching valve based on an output signal from the anode-side gas-liquid detector such that the liquid contained in the fluid in the anode-side discharge path is allowed to flow into the anode-side recovery path.

In a fuel cell system in which a liquid organic fuel or an aqueous solution thereof is directly supplied to the anode of the fuel cell, the present invention makes it possible to recover the fuel or the aqueous solution thereof discharged from the anode effectively and with a space-saving design. Accordingly, it is possible to obtain a fuel cell system that is small, has high energy density, and provides high convenience.

The direct oxidation fuel cell system according to the present invention preferably includes a cathode-side gas-liquid detector comprising a tubular part that is provided in the cathode-side discharge path for distinguishing whether the fluid passing through the tubular part is in gaseous form or liquid form; a cathode-side switching valve that is disposed downstream of the cathode-side gas-liquid detector of the cathode-side discharge path; a cathode-side recovery path for recovering the liquid contained in the fluid discharged from the cathode, the recovery path branching off from the cathode-side switching valve and leading to the fuel tank; and a controller for switching the cathode-side switching valve based on an output signal from the cathode-side gas-liquid detector such that the liquid contained in the fluid in the cathode-side discharge path is allowed to flow into the cathode-side recovery path.

According to this preferable mode, the water discharged from the cathode can be effectively recovered with a space-saving design.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF THE SEVERAL VIEWS OF THE DRAWING

FIG. 1 is a block diagram showing the structure of a fuel cell system in one embodiment of the present invention;

FIG. 2A is a cross-sectional view of a tubular part, filled with gas, of a gas-liquid detector used in a fuel cell system in one embodiment of the present invention;

FIG. 2B is a cross-sectional view of a tubular part, filled with liquid, of a gas-liquid detector used in a fuel cell system in one embodiment of the present invention; and

FIG. 3 is a block diagram showing the structure of a fuel cell system in another embodiment of the present invention.

### DETAILED DESCRIPTION OF THE INVENTION

The present invention relates to a direct oxidation fuel cell system including: a direct oxidation fuel cell comprising at least one cell that comprises an anode, a cathode and a polymer electrolyte membrane inserted between the anode and the cathode; a fuel tank for storing a liquid organic fuel or an aqueous solution thereof; a fuel supply path for supplying the liquid organic fuel or the aqueous solution thereof from the fuel tank to the anode of the fuel cell; an anode-side discharge path for discharging a fluid from the anode of the fuel cell, the fluid comprising gas and liquid that comprise a by-product and a residue of the liquid organic fuel or the aqueous solution thereof; an oxidant supply path for supplying an oxidant to the cathode of the fuel cell; and a cathode-side discharge path for discharging a fluid from the cathode of the fuel cell, the fluid comprising gas and liquid that comprise a by-product and a residue of the oxidant.

The direct oxidation fuel cell system of the present invention is characterized by including: an anode-side gas-liquid detector comprising a tubular part that is provided in the anode-side discharge path for distinguishing whether the fluid passing through the tubular part is in gaseous form or liquid form; an anode-side switching valve disposed downstream of the anode-side gas-liquid detector of the anode-side discharge path; an anode-side recovery path for recovering the liquid contained in the fluid discharged from the anode, the recovery path branching off from the anode-side switching valve and leading to the fuel tank; and a controller for switching the anode-side switching valve based on an output signal from the anode-side gas-liquid detector such that the liquid contained in the fluid in the anode-side discharge path is allowed to flow into the anode-side recovery path.

In a preferable embodiment of the present invention, the direct oxidation fuel cell system further includes: a cathode-side gas-liquid detector comprising a tubular part that is provided in the cathode-side discharge path for distinguishing whether the fluid passing through the tubular part is in gaseous form or liquid form; a cathode-side switching valve that is disposed downstream of the cathode-side gas-liquid detector of the cathode-side discharge path; a cathode-side recovery path for recovering the liquid contained in the fluid discharged from the cathode, the recovery path branching off from the cathode-side switching valve and leading to the fuel tank; and a controller for switching the cathode-side switching valve based on an output signal from the cathode-side gas-liquid detector such that the liquid contained in the fluid in the cathode-side discharge path is allowed to flow into the cathode-side recovery path.

As described above, a gas-liquid two-phase fluid is discharged into the anode-side and cathode-side discharge paths of the fuel cell. When such a gas-liquid two-phase fluid is passed through a tubular flow path, it forms one of the following three gas-liquid two-phase flows, depending on the proportion between the gas phase and the liquid phase.

That is: a bubble flow consisting of a large proportion of liquid and a small proportion of bubbles (gas) scattered therein; a slag flow consisting of almost alternate phases of gas and liquid, the gas phases being formed when bubbles are combined with one another and; and an annular flow in which a small amount of liquid exists only around the tubular wall.

With respect to the anode of the fuel cell, when carbon dioxide produced at the electrode passes through the gas diffusion layer and the fuel flow channel of the separator plate, its bubbles tend to combine to form the gas phase of large bubbles, thereby resulting in formation of a slag flow. With regard to the cathode, when water droplets pass through the gas diffusion layer and the flow channel of the separator plate, they often gather to form large droplets, unless the amount of air supply is significantly heightened or the fuel cell is operated at high temperatures close to the boiling point of water. Further, when the air discharged from the cell that is operated at a temperature higher than the outside air is exposed to the room temperature in the discharge path, the moisture in the air condenses into droplets. Such droplets further combine with the above-mentioned droplets, so that they often form a slag flow.

Further, the following point should also be noted. That is, the fluid discharged from the fuel cell contains a large amount of water as described above, and water has a high surface energy. On the other hand, the carbon material of the separator plate of the fuel cell and the transparent resin material of the light-transmissive tubular part used in the present invention have relatively low surface energies. Therefore, in the flow channel of the separator plate and the pipe of the discharge path, the droplets adhering to the walls of the flow channel and the pipe readily gather and grow until they become as large as the internal diameter of the pipe, and further, the length of the liquid phase in the direction of the pipe also becomes greater.

For the reasons as described above, it is observed that the fluid discharged from the fuel cell often becomes a fluid in which the gas phase and the liquid phase are more clearly separated than the typical slag flow, as it were, an intermittent fluid such that the gas phases and the liquid phases flow alternately.

The present invention takes advantages of the above-described fact that the gas-liquid two-phase fluid discharged from the fuel cell is an intermittent slag flow. The gas-liquid detector distinguishes whether the fluid passing through the tubular part is in gaseous form or liquid form and sends information in the form of a signal to the controller regarding the timing at which the boundary between gas and liquid passes through the gas-liquid detector and the length of the liquid phase in the direction of the discharge path. According to the signal, the controller switches the switching valve, so that the gas and the liquid contained in the fluid flowing through the discharge path can be separated.

Therefore, there is no need to use a conventional ineffective gas-liquid separating tank having a large volume, or there is no need to incorporate an air supply pump for evaporating water or a temperature adjustor so that no electric power is unnecessarily consumed. Accordingly, it is possible to obtain a fuel cell system that is small but has a high energy efficiency.

In a preferable embodiment of the present invention, the tubular part of each of said anode-side and cathode-side discharge paths comprises a transparent material that is highly capable of transmitting light, and each of said anode-side and cathode-side gas-liquid detectors comprises a photosensor that distinguishes whether the fluid passing through said tubular part is in gaseous form or liquid form based on the degree of light transmission or light reflection.

Generally speaking, photosensors offer a quick response and are unlikely to be affected by temperature or the like. Thus, photosensors are suited for performing gas-liquid separation with high accuracy. Moreover, they are widely used and thus excellent in terms of costs and availability.

In the preferable embodiment, light reflection and light transmission are utilized to detect the presence or absence of liquid. This makes it possible to heighten the accuracy of the gas-liquid separation and enhance system realizability.

In another preferable embodiment of the present invention, the fuel or the aqueous solution thereof recovered from the anode-side discharge path and the water recovered from the cathode-side discharge path are stored in the fuel tank. The fuel cell system further includes a liquid volume sensor for detecting the volume of liquid contained in the fuel tank, and a switching valve installed in the cathode-side recovery path. According to the signal sent from the liquid volume sensor, the switching valve installed in the cathode-side recovery path is switched to adjust the water recovery rate such that the liquid volume in the fuel tank is maintained in a predetermined range.

Therefore, even if the amount of water recovered from the fuel cell is excessive, continuous operation becomes possible. Hence, since there is no need to strictly control water balance, allowable operating conditions of the fuel cell system are broadened, which makes it possible to obtain a fuel cell system with high flexibility.

In still another preferable embodiment of the present invention, methanol is used as the liquid organic fuel.

As mentioned previously, the promising fuel to be used as the fuel of direct oxidation fuel cells is methanol, which has a high theoretical energy conversion efficiency, a lower anode reaction overvoltage than other organic fuels, and a higher output. The use of methanol fuel makes it possible to obtain a fuel cell with high energy density that is preferable as the power source of portable electronic devices.

Embodiments of the present invention are now specifically described with reference to drawings.

### Embodiment 1

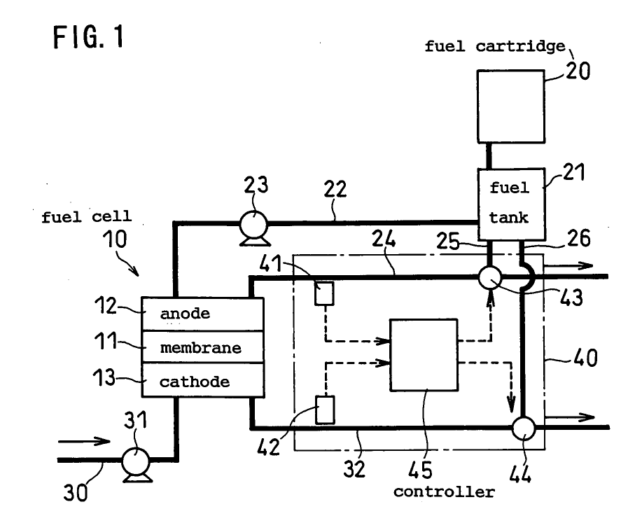

FIG. 1 is a diagram showing the schematic structure of a fuel cell system in one embodiment of the present invention. A fuel cell 10 includes a proton-conductive electrolyte membrane 11, and an anode 12 and a cathode 13 sandwiching the electrolyte membrane 11. The electrolyte membrane 11 is a proton-conductive polymer electrolyte film, typically Nafion (registered trademark). Recently, electrolyte membranes that are less likely to cause fuel crossover than Nafion (registered trademark) are being developed, and such electrolyte membranes can also be used.

The anode 12 and the cathode 13 each comprise a catalyst layer in contact with the electrolyte membrane 11, and a gas diffusion layer disposed on the outer side of the catalyst layer. The catalyst layer comprises a catalyst for activating electrode reaction and a proton-conductive polymer electrolyte. The gas diffusion layer is made of, for example, woven fabric, non-woven fabric or paper of carbon material which has good gas diffusibility and electronic conductivity. The electrolyte membrane 11, the anode 12 and the cathode 13 are usually assembled integrally, and this is called a membrane electrode assembly (MEA). A fuel cell is usually composed of a plurality of such MEAs that are stacked. Such a cell stack is also contemplated by the present invention, though FIG. 1 illustrates a single MEA for the purpose of simplicity.

The MEA is sandwiched between a pair of conductive separator plates. The separator plate has, on the side in contact with the anode, a flow channel for supplying a fuel to the anode and discharging a surplus fuel and by-products therefrom. The separator plate has, on the side in contact with the cathode, a flow channel for supplying an oxidant to the cathode and discharging a surplus oxidant and by-products therefrom. The separator plate comprises a carbon plate that is composed of graphite or graphite-impregnated resin. With respect to the shape of the flow channels, various proposals have been made. Among them are: a serpentine type consisting of one flow channel that meanders on the electrode plane; a serpentine type consisting of a plurality of parallel, meandering flow channels; a parallel multi-flow-channel type consisting of a plurality of linear, parallel flow channels; and a type consisting of a plurality of flow channels that radiate in all directions from the center of a cell.

In a fuel cell including a plurality of MEAs, it is common to supply a fuel and an oxidant (air) from an external source to respective cells through a distribution pipe, called a manifold, and discharge them into another manifold at the outlets of the respective cells. However, the present invention is not to be limited to this.

The electrode catalyst is usually in powder form of noble metal, typically platinum. In some cases a fine metal powder, called “black”, is used, and in other cases a catalyst powder is highly dispersed on carbon powder carrier. Particularly in a reaction system such as methanol, where carbon monoxide is produced as an intermediate product of oxidation process of fuel, a platinum-ruthenium alloy or the like is used as the anode catalyst to reduce poisoning of its active sites. Such a catalyst powder is mixed with a solution containing a polymer electrolyte, typically Nafion (registered trademark), to form a paste, and the paste is applied onto surfaces of an electrolyte membrane and then fixed, for example, by hot pressing to form catalyst layers.

The gas diffusion layer is usually made of carbon paper, carbon cloth, or carbon non-woven fabric having a high electrical conductivity, a high porosity of 70% or more, and a high gas diffusibility. Also, the gas diffusion layer of the cathode is often subjected to a water-repellent treatment using a water-repellent material, such as PTFE, in order to prevent the water that has migrated from the anode and the water produced by the electrode reaction of the cathode from accumulating in the gas diffusion layer, such that the air supply to the catalyst layer is not hampered

The fuel contained in a fuel cartridge 20 is supplied to a fuel tank 21, as appropriate, and in the fuel tank 21 it becomes an aqueous solution having a fuel concentration supplied to the fuel cell. The fuel aqueous solution in the tank 21 is supplied to an inlet-side fuel manifold of the fuel cell 10 through a fuel supply pipe 22 equipped with a pump 23, and then supplied to the anode 12. Surplus fuel and reaction products are discharged from an outlet-side manifold into a discharge pipe 24.

Air serving as the oxidant is supplied to an inlet-side oxidant manifold of the fuel cell 10 through an air supply pipe 30 equipped with a pump 31, and then supplied to the cathode 13. Surplus air and by-products are discharged from an outlet-side manifold into a discharge pipe 32.

The fuel discharge pipe 24 is provided with a gas-liquid detector 41, which determines whether the fluid flowing therethrough is in gaseous form or liquid form. Downstream of the gas-liquid detector 41 of the pipe 24 is a switching valve 43. By the operation of the switching valve 43, the liquid flowing through the pipe 24 is allowed to flow through a branch pipe 25 into the fuel tank 21.

Likewise, the air discharge pipe 32 is provided with a gas-liquid detector 42, which determines whether the fluid flowing through the pipe 32 is in gaseous form or liquid form. Downstream of the gas-liquid detector 42 of the pipe 32 is a switching valve 44. By the operation of the switching valve 44, the liquid flowing through the pipe 32 is allowed to flow through a branch pipe 26 into the tank 21.

The gas-liquid detectors 41 and 42, the switching valves 43 and 44, and a controller 45 constitute a gas-liquid separation system. The controller 45 may be a controller that controls the whole fuel cell system, or a controller designed specifically for controlling the gas-liquid separation system.

The fuel pump 23 is provided for supplying the aqueous fuel solution from the tank 21 to the anode of the fuel cell. The fuel pump 23 needs to provide a considerable pumping pressure to pump a predetermined amount of fuel stably, regardless of the loss of pressure in the fuel supply channel, the rise in internal pressure inside the cells caused by production of carbon dioxide, and the like. A positive displacement pump is generally used.

With regard to the air pump 31, a positive displacement pump may be necessary in such cases where the pressure loss in the flow channel is high due to the design of the air flow channel and the air supply amount of the fuel cell, etc. Otherwise, it is also possible to use a sirocco fan or the like.

The tank 21 makes it possible to reduce the above-mentioned crossover phenomenon by mixing the aqueous fuel solution supplied from the fuel cartridge for supplying fuel 20 with the surplus aqueous fuel solution and water recovered by the gas-liquid separation system 40 to make an aqueous fuel solution having a lower concentration than that stored in the fuel cartridge 20. For pursuing reductions in the size of the fuel cell system, the tank does not need to be an independent tank that occupies a certain volume itself. The tank may be a part of the pipe for supplying fuel to the anode, or may be provided inside the anode or at a position in contact with the anode. However, the volume of the tank 21 is desirably large enough to absorb small fluctuations in the amount of liquid contained therein over time, since liquid is intermittently recovered from the fluid discharged from the anode and the cathode.

The fuel cartridge 20 may be of a detachable type such that it can be detached from the fuel cell system so as to allow the user to replace the cartridge itself, or of a type such that it can be refilled with the fuel or its aqueous solution by the user.

When an unnecessarily excessive amount of water is recovered by the operation of the gas-liquid separation system, it is difficult, in terms of user convenience, to discharge the excessive water from the fuel cell system. Thus, the fuel cartridge may be partitioned with a movable wall such that excessive liquid water can be stored in the space created by consumption of fuel.

The gas-liquid detectors 41 and 42 of the gas-liquid separation system 40 may be any detector as long as it can distinguish between the gas phase and the liquid phase in the pipe. One example is a capacity-type detector that measures the electrical capacity of an electrode placed on the inner wall of the pipe. However, in terms of the above-mentioned responsiveness and versatility, this embodiment describes the use of a photosensor that distinguishes between liquid and gas by irradiating the pipe with a light beam and detecting the reflected light beam. However, the present invention is not to be limited to this.

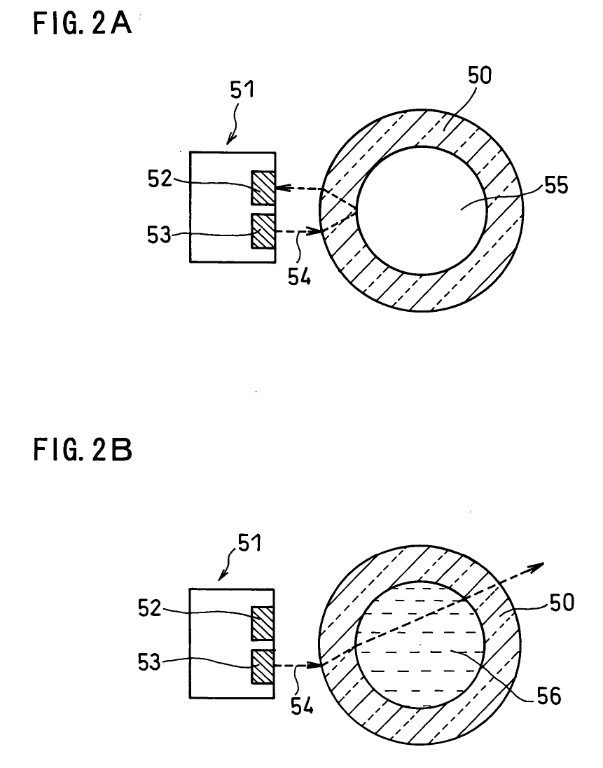

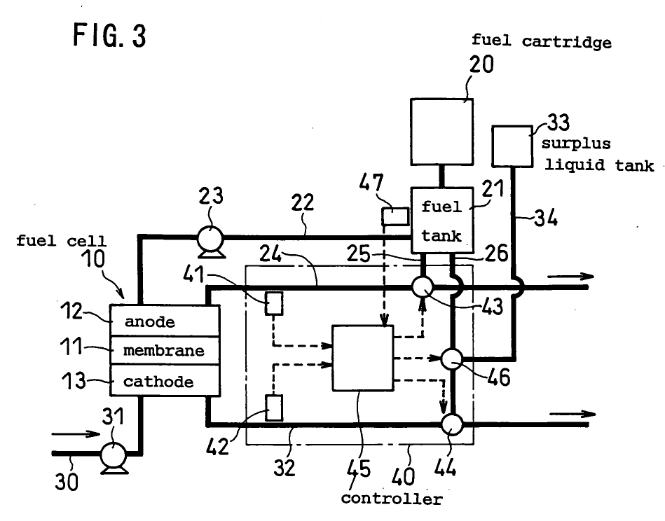

FIG. 2A and FIG. 2B show an exemplary structure of the gas-liquid detector.

The parts of the pipes 24 and 32 corresponding to the gas-liquid detectors 41 and 42 are illustrated as 50 in FIG. 2A and FIG. 2B, and comprise a pipe 50 made of a material capable of transmitting light. Outside of the pipe 50 is a photosensor 51. As illustrated in FIG. 2A, when a light emitter 53 of the photosensor 51 emits a light beam 54 toward the pipe 50, the light beam is reflected by the inner wall of the pipe and part of the reflected light beam is detected by a light receiver 52, if the pipe 50 is filled with gas 55, which has a large refractive index of light. However, as illustrated in FIG. 2B, if the pipe 50 is filled with liquid 56, whose refractive index is not so large, most of the light beam passes through the liquid and the pipe, so that the light beam is not detected by the light receiver 52. The use of a sensor that operates on such a principle makes it possible to detect whether the fluid passing through the pipe 50 with the photosensor is in the gas phase or the liquid phase and to send a signal based on the detected result. It should be noted, however, that such sensor is merely an example and is not to be construed as limiting in any way the present invention.

The material of the pipe 50 of the gas-liquid detector is required to be light-transmissive. However, the discharge pipes 24 and 32 do not need to be light-transmissive all the way from the outlet of the cell to the switching valve, and only the part having the photosensor needs to be light-transmissive. The light-transmissive material may be synthetic resin, such as polytetrafluoroethylene or polycarbonate, glass, or the like.

The information regarding the distinction between the gas phase and the liquid phase made by the gas-liquid detectors 41 and 42 having the photosensor is transmitted to the controller 45. The controller 45 calculates the timing when the boundary between the liquid phase and the gas phase passes through the switching valves 43 and 44 and transmits a signal to the switching valves 43 and 44. The time “lag” between the timing when the boundary between the liquid phase and the gas phase passes through the photosensor and the timing when it passes through the switching valve can be calculated from the distance between the photosensor and the switching valve and the speed of the fluid, i.e., flow rate.

However, it is difficult to accurately calculate the flow rate of the fluid discharged from the fuel cell. The reason is that the fluid discharged from the fuel cell is a gas-liquid two-phase fluid, which varies greatly with not only the amount of gas supplied or discharged but also the amount of liquid contained therein and temperature. Hence, most preferably, a photosensor is provided upstream and downstream of the pipe 50 of the gas-liquid detector so as to detect the boundary between the liquid phase and the gas phase at two locations, such that the difference in the detected times can be used to determine the flow rate.

However, it may be practically difficult to incorporate a large number of photosensors, since it increases the production costs. In such a case, preparations may be made such that the flow rate can be determined according to changes in parameters that affect the flow rate. For example, with respect to the flow rate of the fluid discharged from the anode side, the largest parameter is the amount of carbon dioxide discharged. Hence, the flow rate of the discharged fluid may be measured in advance at varied current densities (i.e., varied amounts of carbon dioxide produced) and the information thus obtained may be stored in the controller 45.

### Embodiment 2

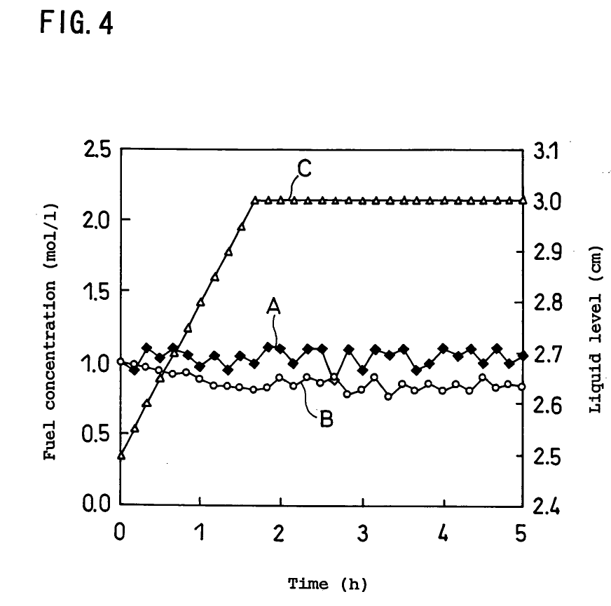

FIG. 3 shows the structure of a fuel cell system of this embodiment. In FIG. 3, the same elements as those in FIG. 1 are given the same numbers and are given no description.

Numeral 47 represents a liquid volume sensor, such as a liquid level sensor, mounted on the fuel tank 21. The pipe 26 that branches off from the cathode-side discharge pipe 32 is equipped with a switching valve 46. A pipe 34 that branches off from the switching valve 46 is connected to a tank 33 for surplus liquid.

As explained in Embodiment 1, it is preferred that the fuel tank 21 be as small as possible and have an ignorable volume in comparison with the volume of the whole fuel cell system. However, in order to achieve such reduction in size of the fuel tank 21, it is necessary that the amount of liquid coming into the tank 21 and the amount of liquid going out of the tank 21 be exactly balanced. Specifically, the amount of liquid supplied from the tank 21 to the anode must be equal to the amount of liquid recovered from the anode and the cathode.

In order to attain such a balance, control is constantly required. For example, as described in Japanese Laid-Open Patent Publication No. 2004-152561, the flow rate of the air supply pump must be adjusted to evaporate excessive water, or the amount of water recovered must be increased by using a condenser.

In this embodiment, such complicated control is unnecessary, and the liquid level sensor 47 is added to the tank 21 that is designed to have a slightly larger volume than the above-mentioned preferable minimized volume. When the amount of liquid recovered from the gas-liquid separation system 40 is excessive, i.e., when a rise in the liquid level in the tank 21 is detected, the switching valve 46 is controlled by the controller 45 such that part of the liquid that is allowed to flow toward the tank 21 by the switching valve 44 will not flow toward the tank 21. The liquid that has not been allowed to flow toward the tank 21 by the switching valve 46 may be stored in the surplus liquid tank 33.

It appears that the surplus liquid tank 33 needs only a very small volume, though it depends on the amount of surplus liquid. The tank 33 may be of a cartridge type such that it is detachable from the fuel cell system so as to allow the user to regularly replace it with a new empty tank, in the same manner as in the fuel cartridge 20. Also, the tank 33 may be integrated with the fuel cartridge 20 such that the tank 33 can be replaced simultaneously with the replacement of the fuel cartridge 20.

Alternatively, the surplus liquid tank 33 can be used in the following manner. The tank 21 is provided with an additional liquid level sensor, and when the amount of liquid in the tank 21 decreases, i.e., when the liquid level becomes lower than a certain level, liquid is supplied to the tank 21 from the surplus liquid tank 33.

It should be noted that in this embodiment the switching valve 46 for allowing surplus liquid to flow to the surplus liquid tank is provided only for the cathode-side liquid recovery pipe 26. This is intended for discarding surplus liquid. That is, the liquid recovered from the anode side contains unused fuel and reaction by-products, thus including substances that are not necessarily acceptable as municipal wastes. Contrary to this, the liquid recovered from the cathode side is composed only of water in most fuel cells, so there is no problem in discarding it. However, the present invention is not to be limited to this.

Examples of the present invention are hereinafter described.

### EXAMPLE 1

A DMFC using methanol as the fuel is described as an example based on FIG. 1 of the present invention.

First, as an electrode catalyst, a conductive carbon powder with a mean primary particle diameter of 30 nm carrying 50% by weight of a noble metal was used for both anode and cathode. The noble metal for the cathode was platinum, while the noble metal for the anode was a platinum-ruthenium alloy in an atomic ratio of 1:1. Each of the anode and cathode catalyst powders was dispersed in water and then mixed with an ethanol solution of a solid polymer electrolyte Flemion (Flemion is a registered trademark of Asahi Glass Co., Ltd.). The resultant mixture was dispersed by means of an ultrasonic diffuser and then defoamed by means of a defoaming device, to form a paste. The content of the solid polymer electrolyte in each paste was adjusted to 30% by weight.

Each paste was applied onto a 50-μm thick polytetrafluoroethylene (PTFE) sheet by means of a bar coater, and the resultant sheet was left at room temperature for 1 day to dry the paste. A polymer electrolyte membrane Nafion 117 (Nafion is a registered trademark of E.I. Du Pont de Nemours & Company) was sandwiched between the PTFE sheet with the anode catalyst layer and the PTFE sheet with the cathode catalyst layer. Using a hot press, the catalyst layers were thermally transferred to the electrolyte membrane, and the PTFE sheets were removed therefrom. This produced the electrolyte membrane with the catalyst layers. Each catalyst layer had the shape of a 5-cm square with an area of 25 cm².

Next, a gas diffusion layer was produced. Carbon paper (TGP-H-090 available from Toray Industries Inc.) was used as a base material. The carbon paper was immersed in a diluted dispersion of tetrafluoroethylene-hexafluoropropylene copolymer (water-repellent agent) (ND-1, available from Daikin Industries, Ltd.) of a predetermined concentration for 1 minute and taken out of the dispersion. Thereafter, it was dried in a hot air dryer at 100% and then baked in an electric furnace at 270° C. for 2 hours. The content of the water repellent agent was 5% by weight. The anode-side and cathode-side gas diffusion layers thus produced were placed on both sides of the above-mentioned electrolyte membrane with the catalyst layers and then hot pressed, to obtain a membrane electrode assembly (MEA).

A separator plate was produced by cutting a “serpentine” (meandering) fuel supply flow channel and a “serpentine” air supply flow channel in opposing sides of a 4 mm-thick graphite plate, respectively. The fuel and air flow channels consisted of one or more grooves, each of which was 1 mm in width and 1 mm in depth. The distance between adjacent grooves was 1 mm.

The above-mentioned MEA was sandwiched between separator plates to form a cell, and 8 cells were stacked to form a fuel cell stack. A current collector plate made of a gold-plated copper plate was attached to each end of the stack, which was connected to an external circuit. Further, a PTFE insulator plate was attached thereto, and this was then sandwiched between stainless steel end plates. The entire unit was secured with a plurality of bolts and nuts.

The separator was provided with an inlet-side manifold aperture and an outlet-side manifold aperture connected to the inlet and outlet of the fuel flow channel, respectively. Likewise, the separator was provided with an inlet-side manifold aperture and an outlet-side manifold aperture connected to the inlet and outlet of the oxidant (air) flow channel, respectively.

The fuel pump used was NP-KX-120 available from Nihon Seimitu Kagaku Co. Ltd., and the air pump used was CM-50 available from Enomoto Micro Pump Mfg. Co. Ltd. The fuel tank was a cylindrical container made of polycarbonate resin, with a diameter of 4 cm, a height of 4 cm, a thickness of 2 mm, and an internal volume of approximately 40 cm³. An aqueous methanol solution with a concentration of 4 mol/L was stored in a fuel cartridge, which was disposed above the fuel tank. A metering valve SS-SS1 available from Swagelok Company was provided between the fuel cartridge and the fuel tank such that a given amount was dropped into the fuel tank depending on the degree of opening of the valve.

The photosensor of the gas-liquid detector was FU-95 available from Keyence Corporation. The light-transmissive tubular part was composed of a pipe made of perfluoro(propylvinylether)-tetrafluoroethylene copolymer, with a diameter of 6 mm and a thickness of 1 mm.

The pipe of the discharge path from the fuel cell stack was divided into two branches, i.e., a recovery pipe and a discharge pipe, and a switching valve was installed at the branch point on the liquid recovery pipe side. That is, the switching valve was designed to electrically open and close the recovery pipe by means of a piezoelectric element, and the valve was closed before the gas phase reached the branch point.

A personal computer was used for controlling the switching valve. The flow rate of a discharged fluid was measured in advance, and based on the measured value, a calculation formula for calculating how many seconds after the detection of liquid by the photosensor of the gas-liquid detector the switching valve should be opened was inputted into the computer. For example, when the flow rate of fuel supplied to the fuel cell stack was 4 cc/min, the flow rate of air 4 L/min, and the amount of power generation 10 W, the flow rate of the boundary between gas and liquid of the fluid discharged from the anode was 2.1 cm/s, and the flow rate of the boundary between gas and liquid of the fluid discharged from the cathode was 15 cm/s.

The fuel cell system having the above configuration was designated as a fuel cell system A.

This fuel cell system A was continuously operated for 5 hours, and during this operation, the fuel in the fuel tank was taken out by a needle. The fuel was then subjected to gas chromatography to measure a change in concentration over time. This result is shown as A in FIG. 4. At the start of operation, 30 cc of a 1 mol/L aqueous methanol solution was filled in the fuel tank. As can be seen from FIG. 4, although the fuel with a concentration of 4 mol/L, which was higher than the initial concentration, was supplied to the fuel tank from the fuel supply cartridge, the methanol concentration in the fuel tank was adjusted to 1 mol/L. This confirmed that the low-concentration aqueous solution of fuel containing unused fuel discharged from the anode and the water discharged from the cathode were recovered by the gas-liquid separation system and transfused to the fuel tank in a proper amount.

Also, in order to ensure that the gas-liquid separation system of the present invention distinguishes between the gas phase and the liquid phase, and to confirm that the gas-liquid separation is accurately performed by the control of the switching valve, a tiny hole was made in the fuel tank, and a bag for recovering gas was connected to the hole. During a 5-hour operation, there was almost no increase in the volume of the gas-collecting bag, which confirmed that the liquid recovered into the liquid fuel tank contained no gas.

Meanwhile, a saucer was placed at the outlet of each of the anode-side and cathode-side gas discharge pipes of the fuel cell system according to this example, to check whether liquid was discharged. During a 5-hour operation, no liquid was found in the saucer placed at the outlet of each discharge pipe. This also confirmed that the gas-liquid separation system of the present invention enables reliable gas-liquid separation.

### EXAMPLE 2

An example based on Embodiment 2 is described.

A fuel cell stack, a gas-liquid separation system and tanks were prepared in the same manner as in Example 1, and a liquid level sensor FU-93 available from Keyence Corporation was mounted on a side face of the fuel tank. As illustrated in FIG. 3, a tank for surplus liquid was disposed such that when the liquid level in the fuel tank became higher than a predetermined value, part of the liquid, i.e., water, discharged from the cathode side of the fuel cell could be transfused into the surplus liquid tank. A signal from the liquid level sensor was transmitted to the personal computer serving as the controller, which operated the switching valve for surplus liquid.

With respect to the operation conditions of the fuel cell, the amount of air supply was reduced to 3 L/min, which was smaller than that of Example 1. As a result, the output of the fuel cell lowered to 9 W, but the amount of liquid in the fuel tank increased. This is because a decrease in the amount of air discharged from the cathode results in a decrease in the amount of water discharged from the fuel cell system and hence the water balance in the fuel cell system becomes positive.

At this time, the flow rate of the boundary between gas and liquid of the fluid discharged form the anode was 1.9 cm/s, and the flow rate of the boundary between gas and liquid of the fluid discharged from the cathode was 11 cm/s.

The fuel cell system having the above configuration was designated as a fuel cell system B.

This fuel cell system B was continuously operated for 5 hours, and during this operation, the concentration of the aqueous methanol solution in the fuel tank was measured. The result is shown as B in FIG. 4. In the same manner as in the fuel cell system A, the concentration was observed to be stable with respect to time. The methanol concentration in the fuel tank lowered slightly in an early stage of the operation, because the amount of liquid filled in the fuel tank at the start of the operation was considerably reduced relative to the set value of the liquid level sensor, as will be described later, and hence the amount of water recovered at the early stage of the operation was relatively large. It was confirmed that the concentration with respect to time would be the same as that of the fuel cell system A if this is corrected.

Also, the liquid level from the bottom of the fuel tank was measured during the 5-hour continuous operation, and the result is shown as C in FIG. 4. The liquid level sensor was set so as to emit a signal when the liquid level was 3.0 cm, but in order to easily confirm the operation of the liquid level sensor, the liquid level of the fuel tank at the start of the operation was set to 2.5 cm. FIG. 4 shows that the liquid level was stable and maintained at the set liquid level of 3.0 cm, thereby confirming the operation of the liquid level sensor and the switching valve.

The fuel cell system according to the present invention is useful as the power source for portable small-sized electronic appliances, such as cellular phones, personal digital assistants (PDAs), notebook PCs, and video cameras. It is also applicable as the power source for electric scooters and the like.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

1. A direct oxidation fuel cell system comprising:
a direct oxidation fuel cell comprising at least one cell that comprises an anode, a cathode and a polymer electrolyte membrane inserted between the anode and the cathode;
a fuel tank for storing a liquid organic fuel or an aqueous solution thereof;
a fuel supply path for supplying the liquid organic fuel or the aqueous solution thereof from said fuel tank to the anode of said fuel cell;
an anode-side discharge path for discharging a fluid from the anode of said fuel cell, said fluid comprising gas and liquid that comprise a by-product and a residue of the liquid organic fuel or the aqueous solution thereof;
an anode-side gas-liquid detector comprising a tubular part that is provided in said anode-side discharge path for distinguishing whether the fluid passing through the tubular part is in gaseous form or liquid form;
an anode-side switching valve disposed downstream of said anode-side gas-liquid detector of said anode-side discharge path;
an anode-side recovery path for recovering the liquid contained in the fluid discharged from the anode, said recovery path branching off from said anode-side switching valve and leading to said fuel tank;
an oxidant supply path for supplying an oxidant to the cathode of said fuel cell;
a cathode-side discharge path for discharging a fluid from the cathode of said fuel cell, said fluid comprising gas and liquid that comprise a by-product and a residue of the oxidant; and
a controller for switching said anode-side switching valve based on an output signal from said anode-side gas-liquid detector such that the liquid contained in the fluid in said anode-side discharge path is allowed to flow into said anode-side recovery path.

2. The direct oxidation fuel cell system in accordance with claim 1, further comprising:
a cathode-side gas-liquid detector comprising a tubular part that is provided in said cathode-side discharge path for distinguishing whether the fluid passing through the tubular part is in gaseous form or liquid form;
a cathode-side switching valve that is disposed downstream of said cathode-side gas-liquid detector of said cathode-side discharge path;
a cathode-side recovery path for recovering the liquid contained in the fluid discharged from the cathode, said recovery path branching off from said cathode-side switching valve and leading to said fuel tank; and
a controller for switching said cathode-side switching valve based on an output signal from said cathode-side gas-liquid detector such that the liquid contained in the fluid in said cathode-side discharge path is allowed to flow into said cathode-side recovery path.

3. The direct oxidation fuel cell system in accordance with claim 1, further comprising a fuel supply tank for supplying the liquid organic fuel to said fuel tank.

4. The direct oxidation fuel cell system in accordance with claim 2, wherein the tubular part of each of said anode-side and cathode-side discharge paths comprises a transparent material that is highly capable of transmitting light, and each of said anode-side and cathode-side gas-liquid detectors comprises a photosensor that distinguishes whether the fluid passing through said tubular part is in gaseous form or liquid form based on the degree of light transmission or light reflection.

5. The direct oxidation fuel cell system in accordance with claim 2, further comprising:
a liquid volume sensor for detecting a liquid volume in said fuel tank;
a switching valve installed in said cathode-side recovery path; and
a controller for switching said switching valve installed in said cathode-side recovery path according to a signal from said liquid volume sensor, to adjust the liquid recovery rate such that the liquid volume in said fuel tank is maintained in a predetermined range.

6. The direct oxidation fuel cell system in accordance with claim 1, wherein said liquid organic fuel is methanol.
